(19) United States
(12) Patent Application Publication
(10) Pub. No.: US 2025/0155246 A1
(43) Pub. Date: May 15, 2025

(54) METHOD OF GENERATING DELIVERY PLAN

(71) Applicant: TOYOTA JIDOSHA KABUSHIKI KAISHA, Toyota-shi (JP)

(72) Inventor: Akinori Morishima, Kanagawa-ken (JP)

(73) Assignee: TOYOTA JIDOSHA KABUSHIKI KAISHA, Toyota-shi (JP)

(21) Appl. No.: 18/765,546

(22) Filed: Jul. 8, 2024

(30) Foreign Application Priority Data
Nov. 14, 2023 (JP) 2023-193561

(51) Int. Cl. G01C 21/34; B60L 53/62; G06Q 10/0835

(52) U.S. Cl. CPC G01C 21/343; B60L 53/62; G01C 21/3469; G06Q 10/08355; B60L 2260/52; B60L 2260/54

(57) ABSTRACT

A method for generating a delivery plan includes the steps of: acquiring a charging request requesting to charge electric power of a specified electric power quantity from a target power supply facility in a specified time period; setting a delivery route that reduces an SOC (state of charge) of a battery based on the charging request in an electrified vehicle where electric power can be received from the target power supply facility in the middle of the delivery route until the electric power can be received from the target power supply facility; and transmitting a power reception command that travels the set delivery route and receives electric power from the target power supply facility to electrified vehicle.

### CROSS-REFERENCE TO RELATED APPLICATION

This application claims priority to Japanese Patent Application No. 2023-193561 filed on Nov. 14, 2023, incorporated herein by reference in its entirety.

### BACKGROUND

### 1. Technical Field

The present disclosure relates to a method of generating a delivery plan.

### 2. Description of Related Art

WO 2020/090252 discloses a delivery plan generation method in which a travelable distance of an electrified vehicle that delivers a package is calculated based on vehicle information on the electrified vehicle and a state of charge (SOC) of a secondary battery mounted on the electrified vehicle, and a delivery plan for the package is generated using delivery destination information for the package and the travelable distance.

Meanwhile, a virtual power plant (VPP) is utilized in a supply-demand adjustment market in which business operators such as aggregators procure the adjustment power for power to be supplied to general power transmission and distribution operators. The VPP provides a function equivalent to a power plant by controlling an energy resource such as a demand facility, a power storage facility, or a power generation facility on the consumer side and an energy resource such as a power generation facility or a power storage facility directly connected to a power system by the owner of the energy resource or a third party such as an aggregator.

In the VPP, the supply and demand of power can be adjusted using a demand response (DR). The DR means that the owner of an energy resource on the consumer side or a third party controls the energy resource to change the supply-and-demand pattern of power. The DR is mainly divided into a downward DR of decreasing the demand or increasing the supply and an upward DR of increasing the demand or decreasing the supply, depending on the pattern of supply-and-demand control.

### SUMMARY

In a delivery plan for an electrified vehicle that delivers a package, it is desired to develop a technique that can be utilized to adjust the supply and demand of power in a time period in which the above-described upward DR is requested, for example. Meanwhile, there is a time period in which a surplus of renewable energy is generated at a site such as a factory that has a power generation facility for renewable energy such as solar light and utilizes the renewable energy. It is also desired that an electrified vehicle that delivers a package should be utilized to adjust the supply and demand of power in a time period in which a surplus of renewable energy is generated at such a site, for example.

However, the delivery plan generation method disclosed in WO 2020/090252 does not consider utilizing an electrified vehicle that delivers a package to adjust the supply and demand of power as exemplified above.

The present disclosure has been made in order to address the above issue, and an object of the present disclosure is to provide a method of generating a delivery plan capable of efficiently adjusting the supply and demand of power using an electrified vehicle that delivers a package.

A certain aspect of the present disclosure provides a method of generating a delivery plan for an electrified vehicle that delivers a package using a computer.

The electrified vehicle includes a battery for travel that stores power received from a power supply facility.

The method of generating a delivery plan includes: acquiring a charge request that requests charge of power in a specified power amount in a specified time period from a target power supply facility;

setting a delivery route that reduces an SOC of the battery based on the charge request before the electrified vehicle capable of receiving power from the target power supply facility in a middle of the delivery route arrives at the target power supply facility; and transmitting a power reception instruction to travel along the set delivery route and receive power from the target power supply facility to the electrified vehicle.

In the above configuration, a delivery route that reduces an SOC of the battery based on the charge request before the electrified vehicle capable of receiving power from the target power supply facility in a middle of the delivery route arrives at the target power supply facility is set. Then, a power reception instruction to travel along the delivery route and receive power from the target power supply facility is transmitted to the electrified vehicle. In this manner, it is possible to set a delivery route that causes the electrified vehicle to consume power so as to meet the charge request, and to supply power to the electrified vehicle from the target power supply facility incorporated in the middle of the delivery route. Thus, it is possible to efficiently adjust the supply and demand of power using the electrified vehicle that delivers a package.

In a certain embodiment, the method of generating a delivery plan further includes predicting a value to which the SOC reduces when the electrified vehicle arrives at the target power supply facility, based on a present value of the SOC and consumption information on a factor that consumes power during travel along the delivery route.

According to the above configuration, it is possible to incorporate a route in which power is easily consumed, such as an area in which traffic congestion is likely to occur and an uphill route, for example, into the delivery route to the target power supply facility. Thus, it is possible to adjust the supply and demand of power more efficiently using the electrified vehicle that delivers a package.

In a certain embodiment, the consumption information includes three-dimensional map information, specifications of devices included in the electrified vehicle including the battery, and position information on a delivery destination for the package in the delivery route.

According to the above configuration, it is possible to predict a value to which the SOC reduces using more detailed information such as geographic information, device information on the electrified vehicle, and power consumed by delivery of a package.

In a certain embodiment, the method of generating a delivery plan further includes excluding, from candidates of the delivery route, a route for which a travel distance in the delivery route exceeds a prescribed distance, a route for which a power consumption amount in the delivery route exceeds a prescribed power amount, and a route for which a delivery time in the delivery route exceeds a prescribed time.

According to the above configuration, it is possible to avoid a loss due to power consumption caused by wasteful detouring.

In a certain embodiment, the method of generating a delivery plan further includes setting a vehicle predicted to be able to receive power in the specified power amount when the vehicle arrives at the target power supply facility based on a present value of the SOC, among a plurality of electrified vehicles, as a vehicle to which the power reception instruction is transmitted.

According to the above configuration, when there is a plurality of candidate vehicles, a vehicle that can receive power in the specified amount when the vehicle arrives at the target power supply facility is selected. Thus, it is possible to adjust the supply and demand of power more efficiently using the electrified vehicle that delivers a package.

According to the present disclosure, it is possible to efficiently adjust the supply and demand of power using an electrified vehicle that delivers a package.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating an overall configuration of a delivery plan generation system according to a first embodiment;

FIG. 2 is a diagram illustrating an exemplary delivery route of an electrified vehicle;

FIG. 3 is a diagram for explaining determination of a delivery route;

FIG. 4 is a flowchart illustrating a processing procedure of processing executed by the delivery plan generation system;

FIG. 5 is a diagram for explaining determination of an electrified vehicle to be delivered in the second embodiment; and

FIG. 6 is a flowchart illustrating a processing procedure of processing executed by the delivery plan generation system.

### DETAILED DESCRIPTION OF EMBODIMENTS

Hereinafter, embodiments of the present disclosure will be described in detail with reference to the drawings. It should be noted that the same or corresponding portions in the drawings are designated by the same reference signs and repetitive description will be omitted.

### First Embodiment

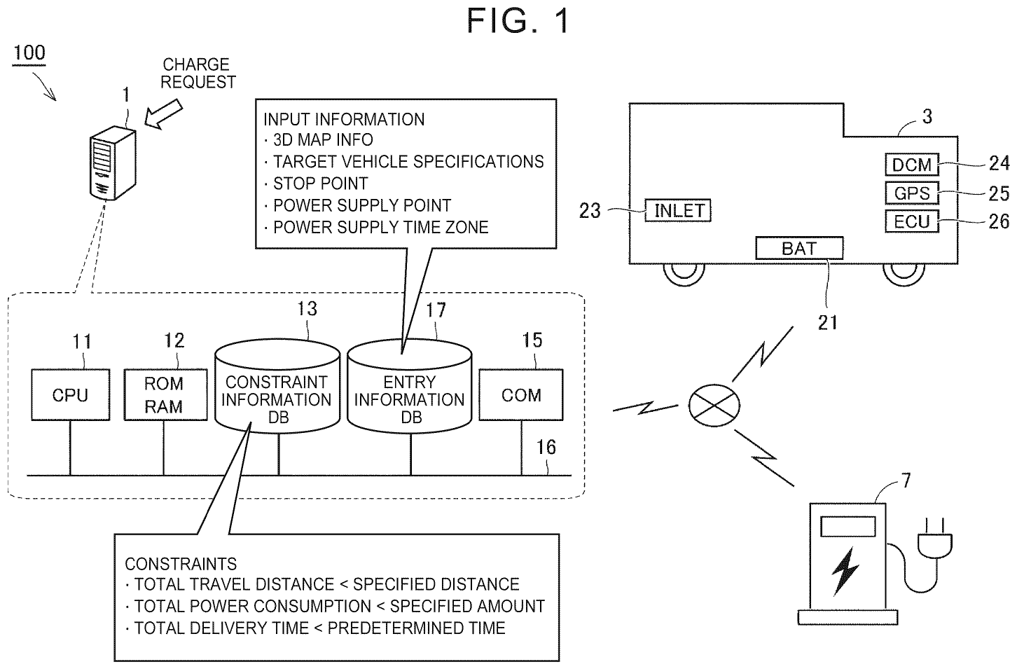

First, a first embodiment will be described. FIG. 1 is a diagram schematically illustrating an overall configuration of a delivery plan generation system 100 according to a first embodiment. The delivery plan generation system is a system that generates a delivery plan of an electrified vehicle 3 that delivers a package.

The delivery plan generation system 100 includes a server device 1 and a power supply facility 7. The power supply facility 7 is a vehicular power supply facility (EVSE: electric vehicle supply equipment), and charges electrified vehicle 3.

The traveling battery 21 included in electrified vehicle 3 stores electric power received from the power supply facility 7. Electrified vehicle 3 is a vehicle that delivers a package while traveling through a delivery route. Electrified vehicle 3 included in the delivery plan generation system 100 is composed of a plurality of electrified vehicle including 3c from electrified vehicle 3a described later.

Electrified vehicle 3 is an electrified vehicle configured to be able to travel using the electric power stored in the battery 21, and is configured to operate as an adjusting force of the electric power system. Electrified vehicle 3 may be a BEV (battery electric vehicle) without an internal combustion engine. Electrified vehicle 3 may be a PHEV (plug-in hybrid electric vehicle) comprising an internal combustion engine. The battery 21 may be a lithium-ion secondary battery, a nickel-hydrogen secondary battery, or the like.

The power supply facility 7 is connected to an electric power system which is an electric power grid constructed by a transmission and distribution facility. This power system supplies AC power to a plurality of power supply facilities 7 in the system.

The server device 1 is connectable to electrified vehicle 3 and the power supply facility 7 via a communication network. The server device 1 is, for example, a device that communicates with a server device A (not shown) belonging to an aggregator. Note that the server device 1 and the server device A may be integrated server devices. An aggregator is an electric utility that bundles a plurality of distributed energy resources (DER: distributed energy resources) to provide a power-management service.

DER in the present embodiment includes a plurality of electrified vehicle 3. The server device 1 operates based on a command from a server device B (not shown) that implements a demand response (DR: demand response) for the respective DER in order to cause the plurality of DER to function as a VPP. The server device B causes these DER to function as a virtual power plant (VPP: virtual power plant) by remotely controlling a plurality of DER including a plurality of electrified vehicle 3.

Prior to starting DR, the server device B transmits a DR request message to the respective DER to the server device 1. DR request message (hereinafter, also referred to as “charge request”) includes a type of DR (e.g., an upward DR and a downward DR), a DR area (e.g., an installation location of an EVSE), and a DR duration (e.g., a DR starting time and a DR ending time). Raising DR is basically a DR requiring upward demand. The downward DR is a DR requesting a demand control or a reverse power flow.

The server device B uses DR to cause a plurality of DER to perform the power adjustment of the power system requested by the server device A or the power adjustment (charge promotion, charge suppression, discharge, power consumption promotion, power consumption suppression, and the like) of the power system awarded in the power marketplace.

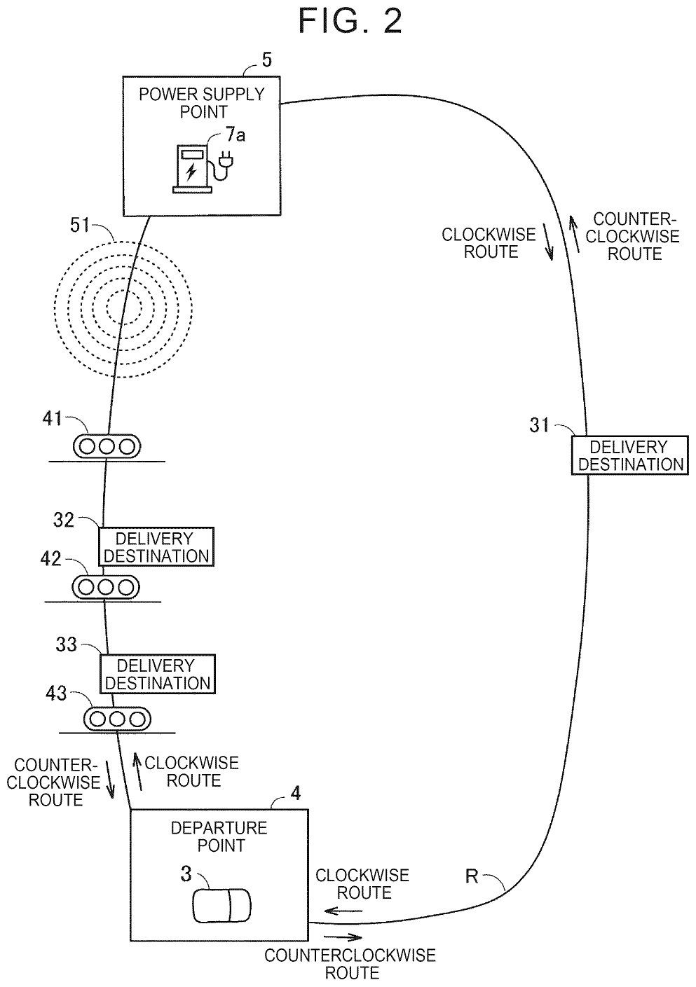

The server device 1 receives a charge request from the server device B and generates an electrified vehicle 3 delivery plan (delivery route). Electrified vehicle 3 delivers the package according to the generated delivery route R (see FIG. 2). Then, the power supply facility 7 designated by the server device 1 is stopped in the middle of the delivery route R, and the commanded amount of electric power is charged.

Hereinafter, the power supply facility 7 designated by the server device 1 is referred to as “target power supply facility 7a”. The target power supply facility 7a is selected from among a plurality of power supply facilities 7 in DR area included in DR request message (charge request).

Alternatively, the target power supply facility 7a may be a power supply facility installed at a site where a renewable energy surplus is generated. Here, the “renewable energy surplus generation base” refers to a base such as a factory that has a power generation facility for renewable energy such as solar light and utilizes the renewable energy. There is a time zone in which an excess of renewable energy is generated at the site.

The server device 1 receives a charging request requesting charging from the target power supply facility 7a installed at the renewable energy surplus generation site in a time period in which the surplus of renewable energy occurs at the renewable energy surplus generation site. Then, an electrified vehicle 3 delivery plan (delivery route) is generated so that electrified vehicle 3 is charged from the target power supply facility 7a installed at the re-energy surplus generation base in a period in which the surplus of renewable energy occurs.

The target power supply facility 7a illustrated in the explanation using FIG. 2 to be described later may be a target power supply facility 7a selected from a plurality of power supply facilities 7 in a DR region included in the above-described DR request message (charge request). The target power supply facility 7a may be a target power supply facility 7a installed at the above-described re-energy surplus generation site.

The server device 1 includes a processor 11, a memory 12, a constraint information database (DB) 13, an input information database (DB) 17, and a communication module (COM) 15, and a data line 16. The processor 11 is, for example, a CPU (central processing unit), and is configured to execute a predetermined arithmetic process described in a program.

The memory 12 includes ROM (read only memory) and RAM (random access memory). ROM stores programs to be executed by the processor 11. RAM temporarily stores data generated by executing a program in the processor 11 and data inputted via the communication module 15. RAM also functions as a temporary data-memory used as a working area.

In response to the charge request, the server device 1 generates a delivery plan of electrified vehicle 3. Electrified vehicle 3 supplies power from the target power supply facility 7a in the middle of the delivery route R. Details will be described later with reference to FIG. 2 and later.

In the input information database 17, consumption information (also referred to as “input information”) used when generating a delivery plan is recorded. The consuming information includes 3D map information which is three-dimensional map information. Consumed data includes target vehicle specifications that are specifications of electrified vehicle 3 device including the battery 21. The consumption information includes a stop point, which is position information of a delivery destination of a package in the delivery route R, a power supply point, and a power supply time period. The server device 1 collects the information and stores the information in the input information database 17.

When a DR request is made, the power supply point means the point data of the plurality of power supply facilities 7 in DR area. The power supply time period is a DR period (a DR starting time and a DR ending time). In the case where a re-energy surplus occurs, the power supply point means the point information of the power supply facility 7 included in the re-energy surplus generation point. The power supply time period is a re-energy surplus time period at the re-energy surplus generation base. The power supply time zone at the base where the renewable energy surplus is generated varies based on weather, solar radiation information, and the like.

In the constraint information database 13, constraint conditions for generating a delivery plan are recorded. For example, a constraint condition (equivalent load condition) such that the travel distance (total travel distance) in the delivery route R is smaller than a predetermined distance is recorded. A restriction condition (equivalent economic efficiency condition) in which the amount of power consumption (total power consumption) in the delivery route R is smaller than a predetermined amount is recorded. In addition, a constraint condition (equivalent delivery time condition) such that the delivery time (total delivery time) in the delivery route R is smaller than the predetermined time is recorded. In order to charge the surplus electric power, such a constraint is imposed for reasons such as inevitably consuming electric power to electrified vehicle 3 and not going away. Due to the constraint of the equivalent load condition, it is possible to suppress the loss of the value as a vehicle by prolonging the travel distance unnecessarily. Suppress excessive power consumption due to constraints imposed by equivalent economic conditions. Constraints based on equivalent delivery time conditions suppress the delivery time from being exceeded.

The communication module 15 includes a communication interface with a network such as the Internet. The communication module 15 is configured to be capable of bidirectional communication with an external device (electrified vehicle 3 (3a to 3c), a power supply facility 7 (7a), a server device A, and a server device B) of the server device 1. The data line 16 is configured to exchange data with each other between devices constituting the server device 1.

In the configuration of the present embodiment, electrified vehicle 3 is capable of contact-type charging via a charging cable extending from the power supply facility 7. It should be noted that a configuration may be adopted in which charging can be performed from a power supply facility capable of charging in a non-contact manner.

Electrified vehicle 3 includes a battery (BAT) 21, an inlet (INLET) 23, a DCM (data communication module) 24, a GPS (global positioning system) receiver 25, and an ECU (electronic control unit) 26.

The battery 21 is a battery pack including a plurality of cells. Each cell is a secondary battery such as a lithium ion battery or a nickel metal hydride battery. The battery 21 supplies electric power for generating the driving force of electrified vehicle 3. The battery 21 also stores electric power generated by an in-vehicle motor generator (not shown). The battery 21 is provided with a voltage sensor and a current sensor (both not shown) for ECU 26 to calculate SOC of the battery 21.

The inlet 23 is configured to be able to insert a charging connector of the power supply facility 7 with a mechanical connection such as a fitting. As the charging connector is inserted, electrified vehicle 3 and the power supply facility 7 are electrically connected to each other, and the battery 21 can be charged by electric power supplied from the power supply facility 7.

DCM 24 is configured such that electrified vehicle 3 and the server device 1 can communicate bidirectionally. Further, DCM 24 is configured so that electrified vehicle 3 and the power supply facility 7 can communicate bidirectionally. GPS receiver 25 identifies the position of electrified vehicle 3 based on radio waves transmitted from satellites (not shown). The server device 1 acquires the position data of each of the plurality of electrified vehicle 3 by communication. ECU 26 controls the devices so that electrified vehicle 3 is in a desired condition on the basis of programs stored in memories (not shown), signals from the sensors, and the like.

FIG. 2 is a diagram illustrating an exemplary delivery route R of electrified vehicle 3. The server device 1 acquires a charging request for requesting to charge the electric power of the specified electric power amount (hereinafter, also referred to as “required electric power amount”) in the specified time period (hereinafter, also referred to as “specified time period”) from the target power supply facility 7a.

As described above, the charge request may be a request based on a DR request message, or may be a request from a re-energy surplus generating site. In the former case, the server device 1 selects one target power supply facility 7a from among a plurality of power supply facilities 7a (a plurality of target power supply facilities 7 in DR areas) included in the charge demand. In the latter case, the power supply facility 7 installed at the site where the renewable energy surplus is generated becomes the target power supply facility 7a.

The server device 1 determines the delivery route R based on the charging request. The delivery route R is a delivery route including a route that lowers SOC of the battery 21 on the basis of the charge demand until reaching the target power supply facility 7a.

The server device 1 performs a power reception command for receiving power from the target power supply facility 7a while traveling through the set delivery route R to electrified vehicle 3. Electrified vehicle 3 can receive power from the target power supply facility 7a in the middle of the delivery route R.

Three delivery destinations from the delivery destinations 31 to 33 are set on the delivery route R. While traveling through the delivery route R, electrified vehicle 3 stops at each of the intermediate delivery destinations 31 to 33 and delivers the package.

In the present example, the delivery route R includes a clockwise route and a counterclockwise route. The clockwise route is a route for delivering the package in a clockwise direction, and is a route that departs from the departure point 4, and returns to the departure point 4 after electrified vehicle 3 delivers the package in the order of the delivery destination 33, the delivery destination 32, and the delivery destination 31. Electrified vehicle 3 charges from the target power supply facility 7a at the power supply point 5 between the delivery destination 32 and the delivery destination 31.

The counterclockwise route is a route for delivering the package counterclockwise, and is a route that departs from the departure point 4 and returns to the departure point 4 after electrified vehicle 3 delivers the package in the order of the delivery destination 31, the delivery destination 32, and the delivery destination 33. Electrified vehicle 3 charges from the target power supply facility 7a at the power supply point 5 between the delivery destination 31 and the delivery destination 32.

Note that the delivery route R of electrified vehicle 3 is not limited thereto, and may be a route that goes further away than the delivery route R in order to avoid a traffic jam. The delivery route R of electrified vehicle 3 may be a route that is delivered in the order of the delivery destination 33, the delivery destination 31, and the delivery destination 32.

In the present embodiment, it is possible to lower SOC of electrified vehicle 3 battery 21 by reaching the power supply point 5 in the clockwise route rather than reaching the power supply point 5 in the counterclockwise route.

As shown in the figure, when the power supply point 5 is reached by the counterclockwise route, the traveling distance is somewhat longer, but it is possible to travel on a flat road at a non-stop except for stopping once at the delivery destination 31. On the other hand, when the power supply point 5 is reached by the clockwise route, it is possible to stop by the signals 41 to 43 in addition to stopping by the delivery destination 33 and the delivery destination 32. This consumes a lot of power. There is also a mountain 51 on the route, which consumes more power by climbing the mountain.

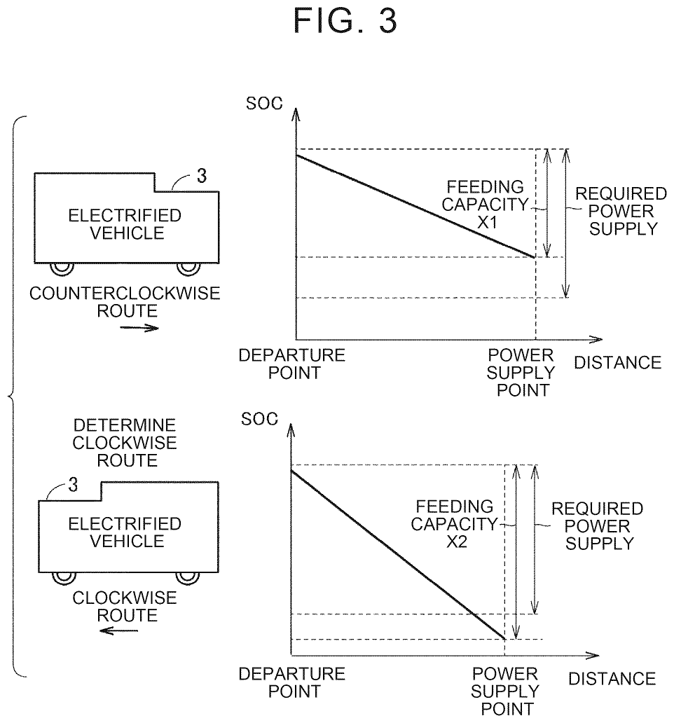

FIG. 3 is a diagram for explaining the determination of the delivery route R. Hereinafter, in the charge request, the amount of electric power designated to be charged from the target power supply facility 7a is referred to as “required electric power amount”.

As shown in FIG. 3, SOC is significantly lower when the vehicle travels from the departure point 4 to the power supply point 5 on the clockwise route than when the vehicle travels from the departure point 4 to the power supply point 5 on the counterclockwise route. The feeding capacity X2 when arriving at the power supply point 5 in the clockwise route is larger than the feeding capacity X1 when arriving at the power supply point 5 in the counterclockwise route.

Then, the feeding capacity X2 when arriving at the power supply point 5 in the clockwise route exceeds the required feeding amount. On the other hand, the feeding capacity X1 when arriving at the power supply point 5 in the counterclockwise route is lower than the required feeding amount. For this reason, the server device 1 determines the distribution on the right-handed route in which the required power supply amount can be supplied, and instructs electrified vehicle 3.

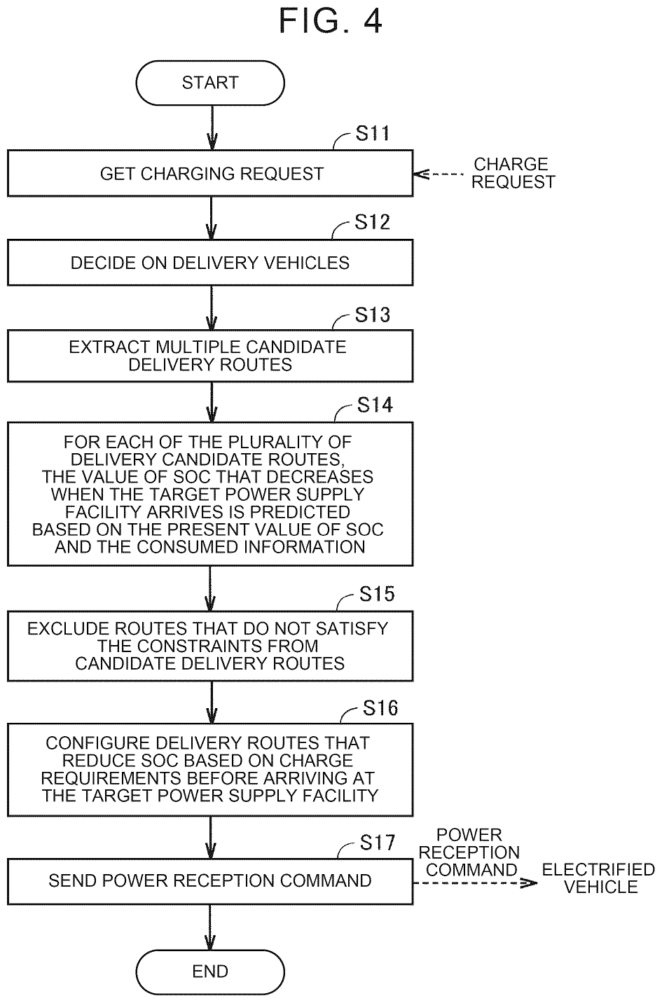

Hereinafter, a description will be given with reference to a flowchart. FIG. 4 is a flowchart illustrating a processing procedure of processing executed by the delivery plan generation system 100. This process is a process for realizing a process for generating a delivery plan electrified vehicle 3 delivering a package.

This flowchart is called from a main routine (not shown) and executed, for example, when a predetermined condition is satisfied. The respective steps are realized by a software process by the server device 1, but may be realized by hardware such as a LSI (large scale integration) disposed in the server device 1. Hereinafter, the term “step” is abbreviated as S.

When this process starts, the server device 1 acquires a charge request in S11. The charging request is a command to charge the electric power of the required electric power quantity from the target power supply facility 7a in the designated period.

The server device 1 sets a vehicle (delivery vehicle) that transmits a power reception command in S12. For example, an electrified vehicle 3 in which a delivery route that travels in the vicinity of the target power supply facility 7a is set in the designated period is set as a delivery vehicle. In the exemplary embodiments illustrated in FIGS. 2 and 3, there is one electrified vehicle 3 that travels through the delivery route R that passes through the target power supply facility 7a and performs delivery, and the vehicle is selected as the delivery vehicle. An exemplary case where there are a plurality of such electrified vehicle will be described in the second embodiment. When there are a plurality of target power supply facility 7a, the number is narrowed down to one.

The server device 1 extracts a plurality of delivery candidates routes in S13. In the example illustrated in FIG. 2, the plurality of delivery candidate routes includes a clockwise route and a counterclockwise route. Further, for example, a route that departs from the departure point 4 and is delivered as the delivery destination 33, the delivery destination 31, and the delivery destination 32 may be included in the delivery candidate route. Further, a route that goes further away than the clockwise route and the counterclockwise route illustrated in FIG. 2 may be included in the delivery candidate route.

In S14, the server device 1 predicts, for each of the plurality of delivery candidate routes, the value of SOC that decreases when the server device arrives at the target power supply facility 7a, based on the present value of SOC and the consumption information (input information DB 17) that is a factor that consumes power while the delivery route R is traveling.

In the exemplary embodiments shown in FIGS. 2 and 3, SOC decreases in the feeding capacity X1 in the counterclockwise route, and SOC decreases in the feeding capacity X2 in the clockwise route. As described above, the consuming information is 3D map information including stop points from the delivery destinations 31 to 33, the signals 41 to 43, and the mountain 51. As a result of the calculation based on the above information, the feeding capacity X2 is predicted to be larger than the feeding capacity X1.

In S15, the server device 1 excludes a route that does not satisfy the constraint from candidates of the delivery route R. The server device 1 excludes, from the candidates of the delivery route R, a route in which the travel distance in the delivery route exceeds a predetermined distance, a route in which the power consumption in the delivery route exceeds a predetermined power amount (predetermined power amount), and a route in which the delivery time in the delivery route exceeds a predetermined time (constraint information DB 13).

For example, in a case where the clockwise route and the counterclockwise route illustrated in FIG. 2 are the shortest routes, the predicted values of the travel distance, the power consumption, and the delivery time when the route is delivered by the shortest route may be calculated. Then, K times (e.g., 1.2 times) the travel distance, the power consumption, and the predicted value of the delivery time may be set to the specified distance (predetermined distance), the specified power amount (predetermined power amount), and the specified time (predetermined time), respectively. By doing so, it is possible to exclude a delivery candidate route that wastefully goes around in order to reduce power consumption.

For example, it is assumed that, as described above, a delivery route that departs from the departure point 4 and is delivered as the delivery destination 33, the delivery destination 31, and the delivery destination 32, and a delivery route that is farther than the clockwise route and the counterclockwise route shown in FIG. 2 are included in the delivery candidate route. If these routes do not satisfy the above constraints, they are excluded from the delivery candidate routes.

In S16, the server device 1 sets, in electrified vehicle 3, a delivery route R that lowers SOC of the battery 21 based on the charge demand before reaching the target power supply facility 7a. In the present example, a clockwise route satisfying the charge request is determined as a delivery route.

In S17, the server device 1 transmits, to electrified vehicle 3, a power reception command for traveling through the set delivery route R and receiving power from the target power supply facility 7a, and ends this process.

As described above, the method for generating the delivery plan includes the step (S11) of obtaining a charging request requesting to charge the electric power of the specified electric power quantity from the target power supply facility 7a in the specified period. The method for generating a delivery plan includes a step of setting a delivery route R for reducing SOC of the battery 21 in an electrified vehicle 3 in which power can be received from the target power supply facility 7a in the middle of the delivery route R, based on a charge demand, until S16 arrives at the target power supply facility 7a. The method for generating the delivery plan includes steps (S17) of transmitting, to electrified vehicle 3, a power reception command for traveling through the set delivery route R and receiving power from the target power supply facility 7a. In this way, it is possible to set a delivery route R that consumes power so as to satisfy the charge requirement, and supply power to electrified vehicle 3 from the target power supply facility 7a incorporated in the middle of the delivery route R. Therefore, it is possible to efficiently adjust the supply and demand of electric power by using electrified vehicle 3 for delivering the baggage.

The method for generating a delivery plan further includes the step of predicting a value of a SOC that decreases when the target power supply facility 7a arrives based on the present value of SOC and the consumption information that is a factor that consumes power while the delivery route R is traveling (S14). According to the above configuration, it is possible to incorporate a route that easily consumes electric power, such as an area where traffic congestion is likely to occur, an uphill route, or the like, into a delivery route to the target power supply facility 7a. Therefore, it is possible to more efficiently adjust the supply and demand of electric power by using electrified vehicle 3 for delivering the baggage.

The consuming information includes three-dimensional map information, specifications of a device included in electrified vehicle 3 including the battery 21, and location information of a delivery destination of the package in the delivery route R. This makes it possible to predict SOC of degradation using more detailed information, such as geographic information, electrified vehicle 3 device information, and power consumed by package delivery.

The method for generating a delivery plan further includes steps (S15) of excluding, from the candidates of the delivery route R, a route in which the travel distance in the delivery route R exceeds a predetermined distance, a route in which the power consumption in the delivery route R exceeds a predetermined power amount, and a route in which the delivery time in the delivery route R exceeds a predetermined time. As a result, it is possible to avoid wasteful loss of power consumption due to wasteful turning.

### Second Embodiment

Next, a second embodiment will be described. In the first embodiment, the delivery route R is determined for electrified vehicle 3 illustrated in FIGS. 2 and 3. On the other hand, in the second embodiment, an example is described in which a plurality of electrified vehicle (3a to 3c) can travel the same delivery route R and any electrified vehicle is assigned as the dispatched vehicles. The configuration of the delivery plan generation system 100 of FIG. 1 shown in the first embodiment is the same in the second embodiment.

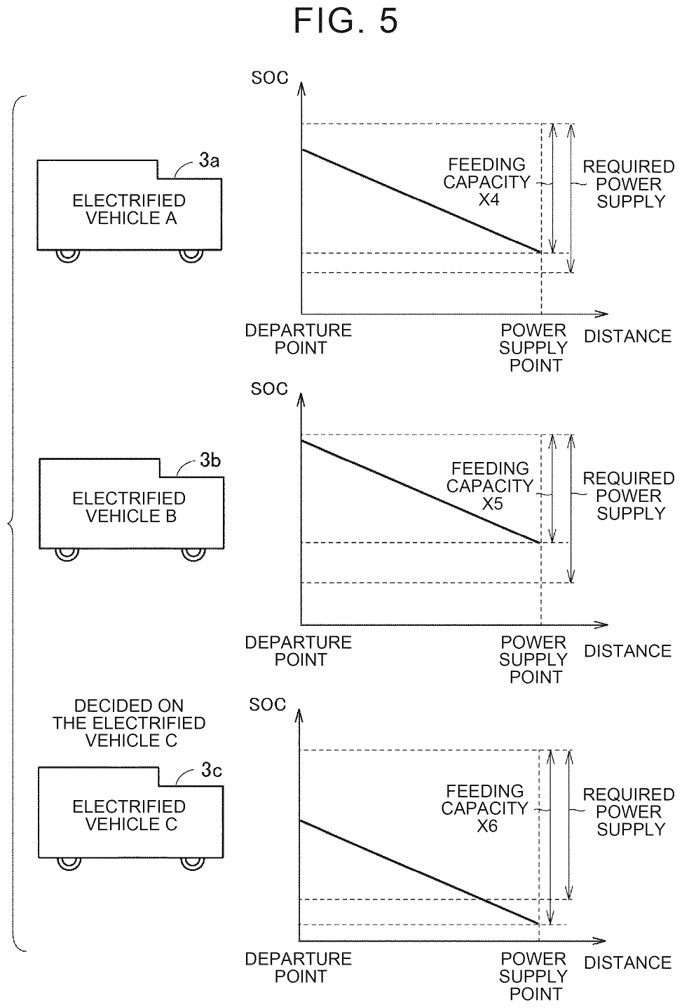

FIG. 5 is a diagram for explaining determination of an electrified vehicle to be delivered in the second embodiment. For example, it is assumed that a 3c can be selected from electrified vehicle 3a as an electrified vehicle capable of traveling through the delivery route R illustrated in FIG. 2. In the following explanation, it is assumed that 3c from electrified vehicle 3a is directed to the power supply point 5 by a clockwise route. It is assumed that when the power supply point 5 is routed counterclockwise, none of 3c from electrified vehicle 3a satisfies the charge requirement.

Electrified vehicles 3a to 3c differ in the specifications of devices such as batteries. SOC at the departure point 4 also differ. SOC at the departure point 4 is lower in the order of electrified vehicle 3c (electrified vehicle C), electrified vehicle 3a (electrified vehicle A), electrified vehicle 3b (electrified vehicle B).

Then, SOC when starting from the departure point 4 and arriving at the power supply point 5 on the clockwise route is lower in the order of electrified vehicle C, electrified vehicle A, electrified vehicle B. In this situation, the relation of the feeding capacity X6 of the electrified vehicle C>the feeding capacity X4 of the electrified vehicle A>the feeding capacity X5 of the electrified vehicle B is established. Then, only the feeding capacity X6 of the electrified vehicle C exceeds the required feed amount. For this reason, the server device 1 selects a electrified vehicle C in which the required power supply amount can be supplied, and instructs electrified vehicle C to travel in a clockwise route and to charge the power from the target power supply facility 7a at the power supply point 5.

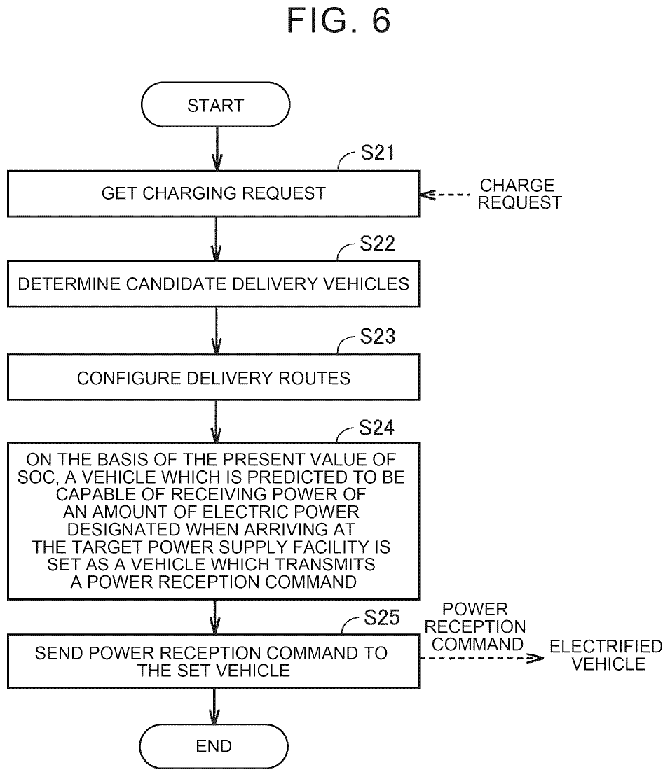

Hereinafter, a description will be given with reference to a flowchart. FIG. 6 is a flowchart illustrating a processing procedure of processing executed by the delivery plan generation system 100.

When this process starts, the server device 1 acquires a charge request in S21. S21 process is the same as S11 process described with reference to FIG. 4. The charging request is a command to charge the electric power of the required electric power quantity from the target power supply facility 7a in the designated period.

In S22, the server device 1 determines delivery-candidate vehicles. In the first embodiment, as illustrated in FIGS. 2 and 3, there is only one electrified vehicle in which a delivery route that travels in the vicinity of the target power supply facility 7a (that can pass through the target power supply facility 7a) is set in the designated time period. On the other hand, in the second embodiment, any one of 3c can be selected from the plurality of electrified vehicle 3a, and the traveling route R that can pass through the target power supply facility 7a can be caused to travel in the designated time period. Therefore, in the present embodiment, three 3c are determined from electrified vehicle 3a as delivery candidates.

The server device 1 sets the delivery route R in S23. For example, one of the delivery candidate vehicles may be selected to execute the process of S13, S14 of FIG. 4, and a route that lowers SOC most may be set as the delivery route R. In this example, a clockwise route is set as the delivery route R.

In S24, the server device 1 sets, based on the present value of SOC among 3c from the plurality of electrified vehicle 3a, a vehicle that is predicted to be capable of receiving the power of the amount of electric power specified when the vehicle arrives at the target power supply facility 7a as a vehicle (dispatched vehicle) that transmits the power reception command. In the exemplary embodiment illustrated in FIG. 5, an electrified vehicle C in which the feeding capacity X6 exceeds the required power supply amount is set as the vehicle.

In S25, the server device 1 transmits a power reception command for traveling through the set delivery route R and receiving power from the target power supply facility 7a to electrified vehicle set as the vehicle, and ends this process. In the present embodiment, a power reception command is transmitted to electrified vehicle C.

After the delivery vehicle candidates are determined in S22, SOC at the time of arrival at the target power supply facility 7a in each of the plurality of delivery candidate routes (clockwise route, counterclockwise route, and the like) may be comprehensively calculated for the respective electrified vehicle serving as the delivery candidate vehicles. Then, a delivery route R and a delivery vehicle for issuing a power reception command may be selected from the combination of the delivery candidate vehicle and the delivery candidate route satisfying the charging request.

As described above, the method for generating the delivery plan further includes the step (S24) of setting, as a vehicle for transmitting the power reception command, a vehicle predicted to be capable of receiving the electric power of the electric power amount designated when the vehicle arrives at the target power supply facility 7a based on the present value of SOC from the plurality of electrified vehicles 3a to 3c. According to the above configuration, when there are a plurality of delivery candidate vehicles, the vehicle capable of receiving the electric power of the specified electric power quantity when the vehicle arrives at the target power supply facility 7a is selected. Therefore, it is possible to more efficiently adjust the supply and demand of electric power by using electrified vehicle for delivering the baggage.

The embodiment disclosed herein shall be construed as exemplary and not restrictive in all respects. The scope of the present disclosure is shown by the claims rather than by the above description of the embodiments, and is intended to include all modifications within the meaning and scope equivalent to those of the claims.

What is claimed is:

1. A method of generating a delivery plan for an electrified vehicle that delivers a package using a computer, the electrified vehicle including a battery for travel that stores power received from a power supply facility, the method comprising:
acquiring a charge request that requests charge of power in a specified power amount in a specified time period from a target power supply facility;
setting a delivery route that reduces a state of charge (SOC) of the battery based on the charge request before the electrified vehicle capable of receiving power from the target power supply facility in a middle of the delivery route arrives at the target power supply facility; and
transmitting a power reception instruction to travel along the set delivery route and receive power from the target power supply facility to the electrified vehicle.

2. The method of generating a delivery plan according to claim 1, further comprising predicting a value to which the SOC reduces when the electrified vehicle arrives at the target power supply facility, based on a present value of the SOC and consumption information on a factor that consumes power during travel along the delivery route.

3. The method of generating a delivery plan according to claim 2, wherein the consumption information includes three-dimensional map information, specifications of devices included in the electrified vehicle including the battery, and position information on a delivery destination for the package in the delivery route.

4. The method of generating a delivery plan according to claim 1, further comprising excluding, from candidates of the delivery route, a route for which a travel distance in the delivery route exceeds a prescribed distance, a route for which a power consumption amount in the delivery route exceeds a prescribed power amount, and a route for which a delivery time in the delivery route exceeds a prescribed time.

5. The method of generating a delivery plan according to claim 1, further comprising setting a vehicle predicted to be able to receive power in the specified power amount when the vehicle arrives at the target power supply facility based on a present value of the SOC, among a plurality of electrified vehicles, as a vehicle to which the power reception instruction is transmitted.
